(19) United States
(12) Patent Application Publication
(10) Pub. No.: US 2008/0048949 A1
(43) Pub. Date: Feb. 28, 2008

(54) Pixel and electroluminescent display using the same

(76) Inventor: Yang Wan Kim, Yongin-si (KR)

Correspondence Address: LEE & MORSE, P.C., 3141 FAIRVIEW PARK DRIVE, SUITE 500, FALLS CHURCH, VA, 22042, US

(21) Appl. No.: 11/826,322

(22) Filed: Jul. 13, 2007

(30) Foreign Application Priority Data
Aug. 24, 2006 (KR) 10-2006-0080302

(51) Int. Cl. G09G 3/30; G09G 3/10

(52) U.S. Cl. 345/80; 315/169.3

(57) ABSTRACT

A pixel includes a first transistor including a gate electrode coupled to a scan line and a first electrode coupled to a data line, a second transistor including a gate electrode coupled to a second electrode of the first transistor, and a first electrode coupled to a first power supply, a third transistor including a first electrode coupled to a second electrode of the second transistor, and a gate electrode coupled to an emission control line, an organic light emitting diode coupled between a second electrode of the third transistor and a second power supply, and a storage capacitor coupled between the gate electrode of the second transistor and the second electrode of the third transistor.

### BACKGROUND OF THE INVENTION

1. Field of the Invention

The present invention relates to pixels, electroluminescent (EL) displays using such pixels, and methods for driving such EL displays. More particularly, the invention relates to pixels, EL displays, e.g., organic light emitting diode (OLED) displays, and methods for driving EL displays using such pixels, which may reduce and/or minimize a number of transistors included in a pixel while also enabling image(s) of uniform or substantially luminance to be displayed.

2. Description of the Related Art

Various types of flat panel displays are being researched and developed. For any given screen size, flat panel displays generally have a lower weight and a lower volume than a CRT of the same screen size. Flat panel displays include, e.g., liquid crystal displays (LCDs), field emission displays (FEDs), plasma display panels (PDPs), and EL displays, e.g., OLED displays.

OLED displays make use of organic light emitting diodes that emit light by re-combination of electrons and holes. In general, OLED displays have advantages such as high response speed(s) and low power consumption.

For EL displays, e.g., OLEDs, to display images having a uniform and/or substantially uniform luminance on a display, pixels of a display should have uniform and/or substantially uniform luminance characteristics. Characteristics, e.g., a threshold voltage of a transistor of each pixel that controls an amount of electric current flowing to an OLED, may prevent the pixels of the display from having uniform and/or substantially uniform luminance characteristics. In general, threshold voltages of transistors may be different as a result of processing variations. Thus, when the threshold voltages of the transistors controlling the flow of electric current to the respective OLED are different, although a data signal corresponding to a same gradation may be supplied to each of the pixels, the respective OLEDs may emit light of different luminance.

Pixels having additional transistors, i.e., pixels having a total of six or more transistors, for compensating for threshold voltage differences in the transistor(s) that controls a current flow to the OLED have been proposed. However, when six or more transistors are included in a pixel circuit, a structure of a pixel circuit becomes complex, and additional wirings for controlling the transistors included in the pixel circuit may be required. Further, although the six or more transistor pixel including the additional transistors may be able to compensate for threshold voltage differences, the additional transistors may not compensate for other characteristics such as, e.g., mobility of the transistor controlling current flow to the respective OLED.

### SUMMARY OF THE INVENTION

The present invention is therefore directed to pixels, and EL displays, e.g., OLED displays using such a pixel, which substantially overcome one or more of the problems due to the limitations and disadvantages of the related art.

It is therefore a feature of an embodiment of the present invention to provide pixels and EL displays, e.g., OLED displays using such a pixel, and a method for driving an EL display including such a pixel having a reduced and/or minimized number of transistors therein while being capable of displaying image(s) of uniform and/or substantially uniform luminance.

At least one of the above and other features and advantages of the present invention may be realized by providing a pixel including a first transistor including a gate electrode coupled to a scan line and a first electrode coupled to a data line, a second transistor including a gate electrode coupled to a second electrode of the first transistor, and a first electrode coupled to a first power supply, a third transistor including a first electrode coupled to a second electrode of the second transistor, and a gate electrode coupled to an emission control line, an organic light emitting diode coupled between a second electrode of the third transistor and a second power supply, and a storage capacitor coupled between the gate electrode of the second transistor and the second electrode of the third transistor.

The first power supply may have a voltage higher than that of the second power supply. The first, second and third transistors may be P-type transistors. The pixel only includes the storage capacitor, the first, second and third transistors, and interconnection lines.

At least one of the above and other features and advantages of the present invention may be separately realized by providing an electroluminescent display including a scan driver for sequentially providing a scan signal to scan lines, and for sequentially providing an emission control signal to emission control lines, a data driver for providing a data signal to data lines, and a plurality of pixels coupled to the scan line and a data line, wherein each of the pixels includes a first transistor including a gate electrode coupled to the scan line and a first electrode coupled to the data line, a second transistor including a gate electrode coupled to a second electrode of the first transistor, and a first electrode coupled to a first power supply, a third transistor including a first electrode coupled to a second electrode of the second transistor, and a gate electrode coupled to an emission control line, an organic light emitting diode coupled between a second electrode of the third transistor and a second power supply, and a storage capacitor coupled between the gate electrode of the second transistor and the second electrode of the third transistor.

The first transistor may be turned-on when the scan signal is supplied to the scan line. The storage capacitor may be charged with a voltage corresponding to the data signal when the first transistor is turned-on. The second transistor may supply an electric current corresponding to the voltage stored in the storage capacitor from the first power supply to the second power supply through the organic light emitting diode. The third transistor may be turned-on or turned-off according to the emission control signal. The storage capacitor may transfer a voltage variation amount of the organic light emitting diode to the gate electrode of the second transistor when an electric current is supplied to the organic light emitting diode.

The voltage variation amount of the organic light emitting diode may correspond to a voltage applied to the organic light emitting diode when an electric current corresponding to a threshold voltage of the second transistor is supplied to the organic light emitting diode. The third transistor may be turned-off when the emission control signal is supplied, and is turned-on in other cases. The emission control signal may be supplied to an i-th (‘i’ is a natural number) emission control line when the scan signal is supplied to an i-th scan line. The first, second and third transistors may be P-type transistors.

At least one of the above and other features and advantages of the present invention may be separately realized by providing a pixel, the pixel may include a first transistor including a gate electrode coupled to a scan line and a first electrode coupled to a data line, a second transistor including a gate electrode coupled to a second electrode of the first transistor, and a first electrode coupled to a first power supply, a third transistor including a first electrode coupled to a second electrode of the second transistor, and a gate electrode coupled to an emission control line, a light emitting diode coupled between a second electrode of the third transistor and a second power supply, and a voltage compensator for at least partially compensating for a threshold voltage variation of the second transistor based on a voltage at an anode terminal of the organic light emitting diode resulting from a current supplied thereto via the second transistor.

The voltage compensator may be coupled between the gate electrode of the second transistor and the second electrode of the third transistor. The light emitting diode may be an organic light emitting diode.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a block diagram of an OLED display according to an exemplary embodiment of the present invention;

FIG. 2 illustrates a circuit diagram of a pixel employable by the exemplary OLED display shown in FIG. 1;

FIG. 3 illustrates a waveform diagram of exemplary driving signals employable for driving the exemplary pixel shown in FIG. 2;

FIGS. 4 and 5 illustrate circuit diagrams including operation states of transistors of the exemplary pixel circuit shown in FIG. 2 resulting from the exemplary driving signals shown in FIG. 3; and

FIG. 6 illustrates a graph of threshold voltages and mobility compensation abilities of a pixel employing one or more aspects of the invention and a conventional pixel.

### DETAILED DESCRIPTION OF THE INVENTION

Korean Patent Application No. 10-2006-0080302, filed on Aug. 24, 2006, in the Korean Intellectual Property Office, and entitled: “Pixel and Organic Light Emitting Diodes Display Using the Same,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the following description, it will also be understood that when an element is described as being connected to another element, the element may be directly connected to the other element, or the element may be connected to the other element via one or more intervening elements. Further, elements and/or features that are obvious to and/or commonly known by those of ordinary skill in the art are omitted for clarity. Like reference numerals refer to like elements throughout the specification.

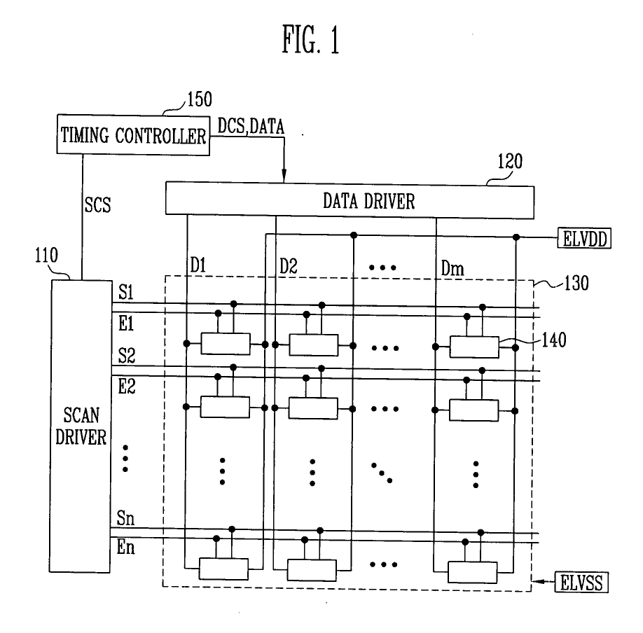

FIG. 1 illustrates a block diagram of an OLED display according to an exemplary embodiment of the present invention.

Referring to FIG. 1, the OLED display may include a pixel portion 130, a scan driver 110, a data driver 120, and a timing controller 150. The pixel portion 130 may include a plurality of pixels 140. The pixels 140 may be coupled with scan lines S1 to Sn, emission control lines E1 to En, and data lines D1 to Dm. The scan driver 110 may drive the scan lines S1 to Sn and the emission control lines E1 to En. The data driver 120 may drive the data lines D1 to Dm. The timing controller 150 may control the scan driver 110 and the data driver 120.

The scan driver 110 may receive the scan driving control signal SCS from the timing controller 150, and may sequentially provide a respective scan signal to the scan lines S1 through Sn. Further, the scan driver 110 may generate emission control signal(s), and may sequentially provide the respective emission control signal to the emission control lines E1 through En. In some embodiments of the invention, the emission control signal(s) may be set to have a greater width, e.g., greater “on” pulse width, than that of the scan signal(s). In some embodiments of the invention, a width of an emission control signal supplied to an i-th emission control line may be set so that it does not overlap with a scan signal supplied to an i-th scan line, i.e., the emission control signal is at an “off” level when the scan signal is at an “on” level.

The data driver 120 may receive a data driving signal DCS from the timing controller 150. The data driver 120 may use the received data driving signal DCS to generate and provide data signal(s) to the data lines D1 through Dm in synchronization with the data signal.

The timing controller 150 may generate the data driving signal(s) DCS and the scan driving signal(s) SCS corresponding to externally supplied synchronizing signals. The data driving signal(s) DCS generated from the timing controller 150 may be provided to the data driver 120, and the scan driving signal(s) SCS may be provided to the scan driver 110. Further, the timing controller 150 may provide externally supplied data DATA to the data driver 120.

The pixel portion 130 may receive power of the first external power supply ELVDD and power of the second external power supply ELVSS, and may supply the received power to the pixels 140. When the pixels 140 receive power from the first power supply ELVDD and the second power supply ELVSS, they may generate light corresponding to the respective data signal. Emission times of the pixels 140 may be controlled by an emission control signal. A voltage of the first power supply ELVDD may be set to be greater than a voltage of the second power supply ELVSS.

FIG. 2 illustrates a circuit diagram of a pixel employable by the exemplary OLED display shown in FIG. 1. More particularly, FIG. 2 illustrates a nm-th pixel connected to a n-th scan line Sn and a m-th data line Dm. However, the exemplary pixel illustrated in FIG. 2 may be employed for one, some or all the pixels 140 of the pixel portion 130.

Referring to FIG. 2, the pixel 140 may include an organic light emitting diode OLED and a pixel circuit 142. In the exemplary case of an nm-th pixel 140, the pixel circuit 142 of the nm-th pixel 140 may be connected to the m-th data line Dm, the n-th scan line Sn, and the n-th emission control line En, and may control the respective organic light emitting diode OLED.

An anode electrode of the organic light emitting diode OLED may be connected to the pixel circuit 142, and a cathode electrode thereof may be connected to the second power supply ELVSS. The organic light emitting diode OLED may generate light having a predetermined luminance corresponding to an electric current supplied thereto from the pixel circuit 142.

When the respective scan signal is supplied to the scan line Sn, the pixel circuit 142 may control an amount of an electric current supplied to the organic light emitting diode OLED based on the respective data signal, which may be supplied to the data line Dm. More particularly, in some embodiments of the invention, a predetermined electric current from a drive transistor included in the pixel circuit 142 may be supplied to the organic light emitting diode OLED and a predetermined voltage may be applied to the respective organic light emitting diode OLED. In such cases, the pixel circuit 142 may control an amount of electric current flowing to the organic light emitting diode OLED based on the predetermined voltage applied to the organic light emitting diode OLED, which may also compensate for some or all of any difference in threshold voltage and/or mobility of the drive transistor of the pixel relative to drive transistors of other pixels, and/or a predetermined threshold voltage and/or mobility.

Referring to FIG. 2, the pixel circuit 142 may include first, second and third transistors Ml to M3, and a storage capacitor Cst.

A gate electrode of the first transistor Ml may be coupled to the n-th scan line Sn, and a first electrode of the first transistor M1 may be coupled with the data line Dm. A second electrode of the first transistor M1 may be coupled to a gate electrode of the second transistor M2, i.e., drive transistor. When the respective scan signal is supplied to the scan line Sn, the first transistor M1 may transfer the respective data signal supplied to the data line Dm to the gate electrode of the second transistor M2.

A first electrode of the second transistor M2 may be coupled with the first power supply ELVDD. A second electrode of the second transistor M2 may be coupled with a first electrode of the third transistor M3. The second transistor M2 may control an amount of an electric current flowing from the first power supply EVDD to the second power supply EVSS through the organic light emitting diode OLED, which may correspond to a voltage applied to the gate electrode of the second transistor M2.

The first electrode of the third transistor M3 may be coupled to the second electrode of the second transistor M2, and a second electrode of the third transistor M3 may be coupled with the organic light emitting diode OLED. A gate electrode of the third transistor M3 may be coupled to the emission control line En. When the emission control signal is provided to the emission control line En, e.g., when the emission control line is in an “on” state, the third transistor M3 may be turned-off, whereas in remaining cases, e.g., when the emission control line is in an “off” state, the third transistor M3 may be turned-on.

One terminal of the storage capacitor Cst may be coupled to a gate electrode of the second transistor M2, and another terminal thereof may be coupled to the second electrode of the third transistor M3, i.e., the anode electrode of the organic light emitting diode OLED. When the first transistor M1 is turned-on, the storage capacitor Cst may be charged with a voltage corresponding to a data signal. Further, the storage capacitor Cst may transfer a voltage variation amount corresponding to a voltage difference at the anode electrode of the organic light emitting diode OLED to the gate electrode of the second transistor M2.

In the exemplary embodiment illustrated in FIG. 2, each of the transistors M1, M2, M3 are P-type transistors. However, embodiments of the invention are not limited to such transistors.

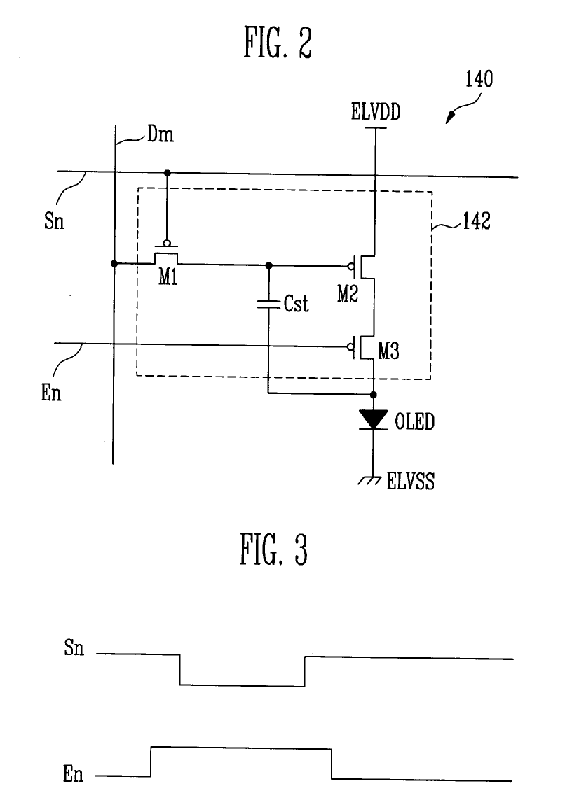

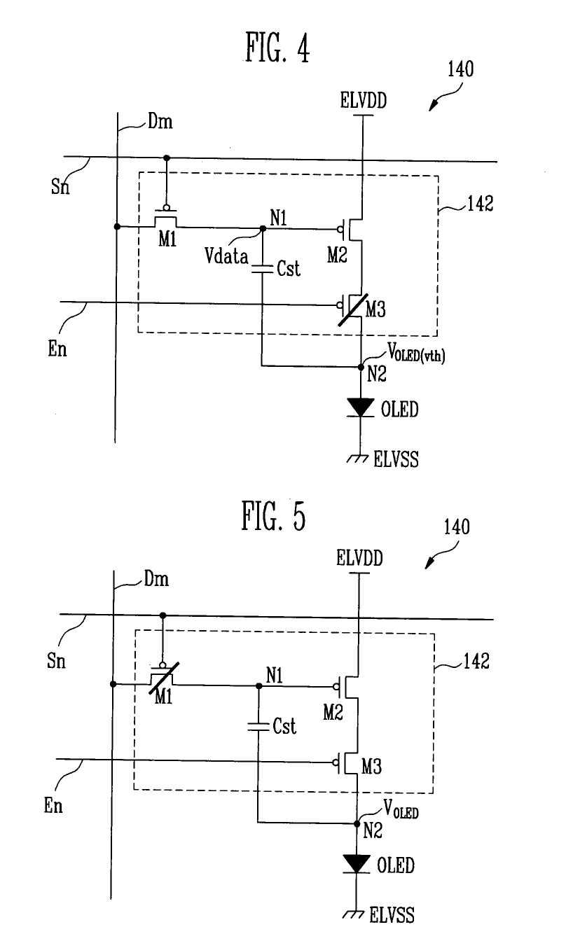

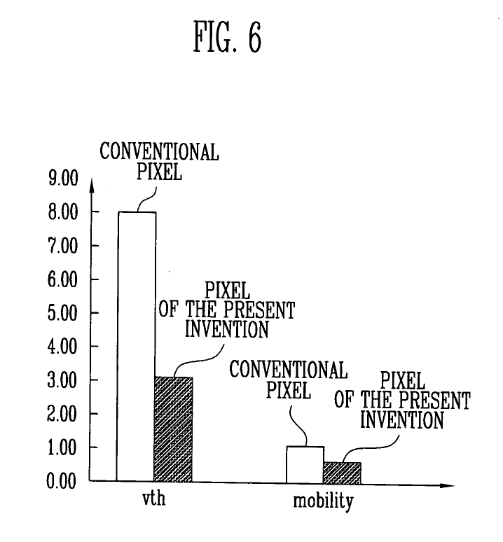

FIG. 3 illustrates a waveform diagram of exemplary driving signals employable for driving the exemplary pixel shown in FIG. 2. FIGS. 4 and 5 illustrate circuit diagrams including operation states of transistors of the exemplary pixel circuit shown in FIG. 2 resulting from the exemplary driving signals shown in FIG. 3.

Referring to FIG. 3, before a scan signal, e.g., a low level signal portion, is supplied to a scan line Sn, an emission control signal, e.g., a high level signal portion, may be supplied to an emission control line En, so that the third transistor M3 may be turned-off. Next, the scan signal, e.g., the low level signal portion, may be supplied to the scan line Sn, so that the first transistor M1 may be turned-on.

When the first transistor M1 is turned-on, as shown in FIG. 4, a data voltage Vdata corresponding to a data signal may be applied to a first node N1. Referring to FIG. 4, when the first transistor M1 is turned-on, the third transistor M3 may be turned off, and a threshold voltage V_{OLED} (V_{TH}) of the organic light emitting diode OLED may be applied to the second node N2. Accordingly, the storage capacitor Cst may be charged with a voltage corresponding to a difference between a data voltage Vdata and the threshold voltage V_{OLED} (V_{TH}) of the organic light emitting diode OLED.

Thereafter, a supply of the scan signal to the scan line Sn and a supply of the emission control signal to the emission control line En may stop, e.g., at that stage, the scan signal may have a high level and the emission control signal may have a low level. Accordingly, as shown in FIG. 5, the first transistor M1 may be turned-off and the third transistor M3 may be turned-on.

At this stage, the second transistor M2 may transfer an electric current corresponding to the voltage applied to the first node N1 to the organic light emitting diode OLED. In such cases, a voltage of the second node N2 may change according to following Equation 1:

ΔN2=V_{OLED}−V_{OLED} (Vth), (Equation 1)

where, V_{OLED} represents a voltage applied to the organic light emitting diode OLED corresponding to an electric current flowing through the organic light emitting diode OLED.

Accordingly, a voltage V_{OLED} may be increased in proportion to an amount of an electric current flowing through the organic light emitting diode OLED.

With reference to the Equation 1, a voltage of the second node N2 may vary by a voltage applied to the organic light emitting diode OLED when an electric current flows from the threshold voltage V_{OLED} (Vth) of the organic light emitting diode OLED. Accordingly, a voltage of the first node N1, which may be in a floating state, may vary corresponding to a voltage variation amount of the second node N2 by the storage capacitor Cst.

In embodiments of the invention, because the voltage variation amount of the second node N2 may change based on a threshold voltage of the second transistor M2, i.e., based on an amount of an electric current flowing to the organic light emitting diode OLED, the threshold voltage of the second transistor M2 may be compensated for corresponding to the voltage variation at the second node N2.

Thus, in embodiments of the invention, the second transistor M2 may then transfer an electric current corresponding to a voltage applied to the first node N1 to the organic light emitting diode OLED, so that the organic light emitting diode OLED may generate light of a predetermined luminance corresponding to an electric current supplied thereto.

As described earlier, embodiments of the present invention may feed back a voltage applied to the organic light emitting diode OLED to a gate electrode of the second transistor M2 corresponding to an amount of an electric current supplied to the organic light emitting diode OLED from the second transistor M2 using a storage capacitor Cst. Here, because the electric current supplied to the organic light emitting diode OLED from the second transistor M2 may be affected by the threshold voltage of the second transistor M2, non-uniformity(ies) in the threshold voltage of the second transistor M2 may be substantially and/or completely compensated for.

In other words, an amount of an electric current flowing into an organic light emitting diode OLED may change corresponding to a threshold voltage of the second transistor M2, thereby changing an electric current flowing to the organic light emitting diode OLED. In this case, a difference of the voltage variation amount in the second node N2 may be supplied to the gate electrode of the second transistor M2 to substantially and/or completely compensate a threshold voltage of the second transistor M2.

In some embodiments of the invention, each of the pixels 140 may be divided into a red pixel R, a green pixel G, and a blue pixel B. The red pixel R may include a red organic light emitting diode OLED(R), the green pixel G may include a green organic light emitting diode OLED(G), and the blue pixel B may include a blue organic light emitting diode OLED(B). Different degradation degrees in the red organic light emitting diode OLED(R), the green organic light emitting diode OLED(G) and/or the blue organic light emitting diode OLED(B) may be set according to a respective length of time. The threshold voltage V_{OLED} (V_{TH}) of the respective organic light emitting diode OLED may vary according to the degradation degrees.

On the other hand, in some embodiments of the present invention, because the second node N2 may vary from the threshold voltage V_{OLED} (V_{TH}) of the organic light emitting diode OLED to a voltage V_{OLED} applied to the organic light emitting diode OLED, the degradation of the organic light emitting diode OLED may be substantially and/or completely compensated for. More particularly, e.g., because a gate electrode of the second transistor M2 may change corresponding to a variation amount of the threshold voltage V_{OLED} (V_{TH}) of the organic light emitting diode OLED, which may be varied according to the degradation of the organic light emitting diode OLED, degradation characteristics of the organic light emitting diode OLED may be substantially and/or completely compensated for.

FIG. 6 illustrates a graph of a threshold voltages and mobility compensation abilities of a pixel employing one or more aspects of the invention and a conventional pixel. A Y axis of FIG. 6 corresponds to an amount of influence of a deviation of a threshold voltage Vth and mobility on a scale of 0 to 10. The relationships illustrated in FIG. 6 may correspond to about a 40 mV deviation in the threshold voltage V_{TH} of a drive transistor and about a 10 m²/Vs deviation in the mobility of the drive transistor.

As illustrated in FIG. 6, for conventional pixels, a threshold voltage Vth of the drive transistor significantly influences an amount of electric current flowing through the pixel. In other words, a significant difference in an electric current amount flowing through each pixel significant may occur as a result of a deviation in the threshold voltage of the drive transistor. Relative to conventional pixels, a pixel(s) employing one or more aspects of the present invention may be less influenced by a deviation in threshold voltage of the drive transistor. Accordingly, relative to conventional pixels, embodiments of the invention enable smaller differences in amounts of electric current flowing through each pixel as a result of a deviation in the threshold voltage of the drive transistor. Thus, embodiments of the invention, may enable an image(s) of uniform luminance to be displayed by reducing and/or eliminating an influence of deviation(s) in threshold voltage and/or mobility of drive transistors of pixels of a display. Further, embodiments of the invention, enable an amount of variation of an electric current resulting from a deviation in mobility to be reduced relative to conventional pixels and/or eliminated.

As discussed above, in a pixel and an OLED display using such a pixel according to one or more aspects of the present invention, a voltage at a gate electrode of a drive transistor may correspond to an electric current amount flowing to the organic light emitting diode, and thus, embodiments of the invention may substantially and/or completely compensate for non-uniformity(ies) in the threshold voltage of the drive transistor. Because the voltage feedback to the gate electrode of the drive transistor may be determined according to an electric current amount supplied from the drive transistor, the mobility of the drive transistor may be substantially and/or completely compensated. In some embodiments of the invention, a threshold voltage of the drive transistor may be substantially and/or completely compensated using only three transistors and two capacitors. Embodiments of the invention may substantially and/or completely compensate for degradation of an organic light emitting diode.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A pixel, comprising:
a first transistor including a gate electrode coupled to a scan line and a first electrode coupled to a data line;
a second transistor including a gate electrode coupled to a second electrode of the first transistor, and a first electrode coupled to a first power supply;
a third transistor including a first electrode coupled to a second electrode of the second transistor, and a gate electrode coupled to an emission control line;
an organic light emitting diode coupled between a second electrode of the third transistor and a second power supply; and
a storage capacitor coupled between the gate electrode of the second transistor and the second electrode of the third transistor.

2. The pixel as claimed in claim 1, wherein the first power supply has a voltage higher than that of the second power supply.

3. The pixel as claimed in claim 1, wherein the first, second and third transistors are P-type transistors.

4. The pixel as claimed in claim 1, wherein the pixel only includes the storage capacitor, the first, second and third transistors, and interconnection lines.

5. An electroluminescent display, comprising:
a scan driver for sequentially providing a scan signal to scan lines, and for sequentially providing an emission control signal to emission control lines;
a data driver for providing a data signal to data lines; and
a plurality of pixels coupled to the scan line and a data line,
wherein each of the pixels includes:
a first transistor including a gate electrode coupled to the scan line and a first electrode coupled to the data line;
a second transistor including a gate electrode coupled to a second electrode of the first transistor, and a first electrode coupled to a first power supply;
a third transistor including a first electrode coupled to a second electrode of the second transistor, and a gate electrode coupled to an emission control line;
an organic light emitting diode coupled between a second electrode of the third transistor and a second power supply; and
a storage capacitor coupled between the gate electrode of the second transistor and the second electrode of the third transistor.

6. The display as claimed in claim 5, wherein the first transistor is turned-on when the scan signal is supplied to the scan line.

7. The display as claimed in claim 5, wherein the storage capacitor is charged with a voltage corresponding to the data signal when the first transistor is turned-on.

8. The display as claimed in claim 5, wherein the second transistor supplies an electric current corresponding to the voltage stored in the storage capacitor from the first power supply to the second power supply through the organic light emitting diode.

9. The display as claimed in claim 5, wherein the third transistor is turned-on or turned-off according to the emission control signal.

10. The display as claimed in claim 5, wherein the storage capacitor transfers a voltage variation amount of the organic light emitting diode to the gate electrode of the second transistor when an electric current is supplied to the organic light emitting diode.

11. The display as claimed in claim 5, wherein the voltage variation amount of the organic light emitting diode corresponds to a voltage applied to the organic light emitting diode when an electric current corresponding to a threshold voltage of the second transistor is supplied to the organic light emitting diode.

12. The display as claimed in claim 5, wherein the third transistor is turned-off when the emission control signal is supplied, and is turned-on in other cases.

13. The display as claimed in claim 12, wherein the emission control signal is supplied to an i-th (‘i’ is a natural number) emission control line when the scan signal is supplied to an i-th scan line.

14. The display as claimed in claim 5, wherein the first, second and third transistors are P-type transistors.

15. A pixel, comprising:
a first transistor including a gate electrode coupled to a scan line and a first electrode coupled to a data line;
a second transistor including a gate electrode coupled to a second electrode of the first transistor, and a first electrode coupled to a first power supply;
a third transistor including a first electrode coupled to a second electrode of the second transistor, and a gate electrode coupled to an emission control line;
a light emitting diode coupled between a second electrode of the third transistor and a second power supply; and
voltage compensation means for at least partially compensating for a threshold voltage variation of the second transistor based on a voltage at an anode terminal of the organic light emitting diode resulting from a current supplied thereto via the second transistor.

16. The pixel as claimed in claim 15, wherein the voltage compensation means is coupled between the gate electrode of the second transistor and the second electrode of the third transistor.

17. The pixel as claimed in claim 16, wherein the light emitting diode is an organic light emitting diode.
